(19) United States
(12) Patent Application Publication
(10) Pub. No.: US 2002/0165702 A1
(43) Pub. Date: Nov. 7, 2002

(54) Method and system for optimization of apodization circuits

(75) Inventor: Benoit R. Veillette, Shrub Oak, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/847,138

(22) Filed: May 2, 2001

(51) Int. Cl. G06G 7/48; G06G 7/56; G06F 17/50

(52) U.S. Cl. 703/14

(57) ABSTRACT

A method is provided for the optimization of apodization circuits. An apodization circuit is provided and a multiplier within the apodization circuit is replaced with a first replacement multiplier. A window function of the apodization circuit is then replaced with a first replacement window function.

### FIELD OF THE INVENTION

In general, the invention relates to signal processing. More specifically, the invention relates to the creation of apodization circuits used in signal processing and in particular, to a method for optimization of apodization circuits prior to manufacturing.

### BACKGROUND OF THE INVENTION

Many ultrasound scanner systems use a phased array of piezoelectric transducers. The ultrasound beam can be focused and steered within a 2-D sector by delaying the pulse for each transducer independently such that all contributions are in phase at the focus point. When all the pulses have the same amplitude, the ultrasound beam exhibits side lobes that reduce the signal-to-noise ratio (SNR) and thus the image quality. This can be solved with a technique called apodization where the amplitude of the pulse at each transducer is set according to a spatial window. However, this technique requires multipliers for scaling the pulse, on both the transmitter and the receiver sides. The multipliers require an increase of silicon area and power consumption, and are thus more expensive than techniques without apodization. Currently, there are no cost verses performance trade-offs available other than the system with apodization and the system without.

Therefore, it would be desirable to have a method and system that would improve upon the above-mentioned situation, and related situations in which the benefits of apodization circuits are required but cost prohibitive.

### SUMMARY OF THE INVENTION

One aspect of the invention provides a method for the optimization of apodization circuits. An apodization circuit is provided and a multiplier within the apodization circuit is replaced with a first replacement multiplier. A window function of the apodization circuit is then replaced with a first replacement window function.

Another aspect of the invention provides a further method for the optimization of apodization circuits by determining a first efficiency rate for the apodization circuit with the first replacement multiplier. The first replacement multiplier within the apodization circuit is then replaced with a second replacement multiplier and a second efficiency rate is determined for the apodization circuit with the second replacement multiplier. The first efficiency rate is compared with the second efficiency rate and the apodization circuit with the first replacement multiplier or the apodization circuit with the second replacement multiplier is selected,

Another aspect of the invention provides a system for optimization of apodization circuits. The system includes a means for providing an apodization circuit and replacing a multiplier within the apodization circuit with a first replacement multiplier. A means is provided for replacing a window function of the apodization circuit with a first replacement window function.

Another aspect of the invention further provides a system for optimization of apodization circuits with a means for determining a first efficiency rate for the apodization circuit with the first replacement multiplier. Further included is a means for replacing the first replacement multiplier within the apodization circuit with a second replacement multiplier. Additionally, a means for determining a second efficiency rate for the apodization circuit with the second replacement multiplier, a means for comparing the first efficiency rate with the second efficiency rate, and a means for selecting one of the apodization circuits based on the comparing of the first efficiency rate with the second efficiency rate.

An additional aspect of the present invention provides a computer readable medium storing a computer program including computer readable code for providing an apodization circuit and replacing a multiplier within the selected apodization circuit with a first replacement multiplier. Computer-readable program code is provided for replacing a window function of the apodization circuit with a first replacement window function.

An additional aspect of the present invention further provides a computer readable medium storing a computer program including computer readable program code for determining a first efficiency rate for the apodization circuit with the first replacement multiplier, and for replacing the first replacement multiplier within the apodization circuit with a second replacement multiplier. Further, computer-readable program code is provided for determining a second efficiency rate for the apodization circuit with the second replacement multiplier, and for comparing the first efficiency rate with the second efficiency rate. Further, computer-readable program code is provided for selecting between the apodization circuit with the first replacement multiplier and the apodization circuit with the second replacement multiplier, based on the comparing of the first efficiency rate with the second efficiency rate.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram illustration of beamforming, in accordance with the present invention;

FIG. 2 is a block diagram illustrating one embodiment of a circuit in accordance with the FIG. 1;

FIGS. 3A-3C are block diagrams illustrating alternative multipliers for the device of FIG. 2;

FIG. 4 is an illustration of signal encoding, as required by the multipliers of FIGS. 3A-3C; and

FIG. 5 is a flow chart representation of a method performed on the device of FIG. 2 for optimization.

### DETAILED DESCRIPTION OF THE PRESENTLY PREFERRED EMBODIMENTS

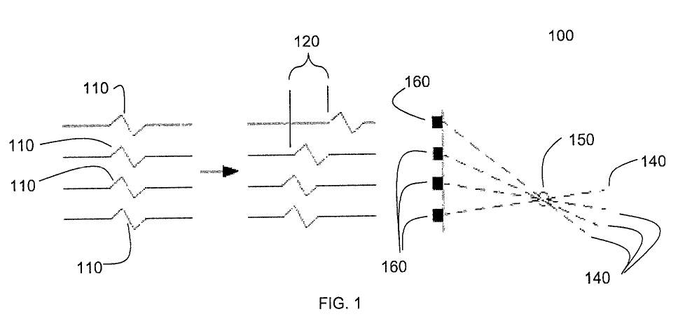

One embodiment of the invention relates to the use of transducers in a linear array. An additional embodiment of the invention relates to ultrasound systems using electromagnetic acoustic transducers in a linear array. Further, an embodiment of the invention relates to high-end ultrasound systems employing piezoelectric transducers in a linear array. FIG. 1 may relate to the high-end ultrasound systems employing piezoelectric transducers in a linear array.

Illustrated in FIG. 1 are multiple pulse signals 110 manipulated in a manner known as beamforming 100. The pulse signals are applied to the transducers 160, which react by producing ultrasound waves 140. At each point of a scanned surface or plane, the contribution from the ultrasound waves 140 of each transducer 160 can be added, taking into account the phase. From this, the maximum signal amplitudes at all points may be assembled to create a 2-D function known as a pressure field. Typically, an ultrasound system can provide pressure field with electronically adjustable focus, distance, and direction. The focus 150 may be moved around by delaying the pulse signal 120 at each transducer 160 so that all ultrasound waves 140 are in phase at that point 150. This is the process of beamforming 100. The pulse signals 110 applied to the transducers 140 may be sinewaves, and may have a raised cosine temporal window or envelop. A window may be any function that has a finite non-zero length. Beamforming 100 can be used for generating an ultrasonic beam, and for collecting an echo of the ultrasonic beam. A point-spread function is the product of the transmit and the receive pressure fields as is known in the art. For one embodiment of the invention, examination of the point-spread function may be used as a metric for the quality of an ultrasound scan.

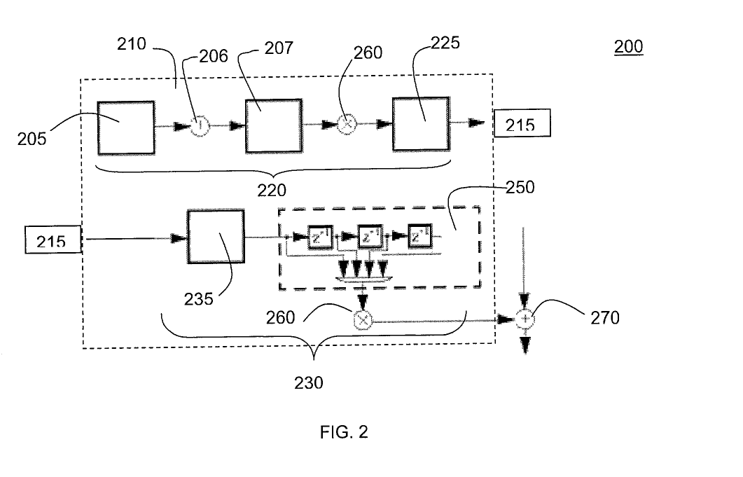

FIG. 2 is a block diagram illustrating one embodiment of a beamforming circuit 200, in accordance with the invention. In one embodiment of the invention, the transmit circuit 220 and receive circuit 230, for a single piezoelectric transducer 215 combine to create a channel 210 of the beamforming circuit 200. The circuit 220 is one embodiment of a beamforming circuit that can be used for transmit beamforming on a single channel. A phase counter 205 may monotonically increase the phase used to reference a sinewave signal stored digitally in a look-up table (LUT) 207. A channel-specific delay can be added 206 to the phase for the purpose of beamforming. The output of the LUT 207 may be turned into an analog signal by means of a digital-to-analog converter (DAC) 225. The signal may then be transmitted to the piezoelectric transducer 215. One embodiment of a complimentary circuit to the beamforming transmit circuit 220 may be illustrated as a receive circuit 230. An embodiment of the invention may first digitize the signal 235 from the transducer 215. The signal may then be delayed for focusing. A digital delay 250 can be implemented for one embodiment of the invention with a string of registers and a multiplexer, or with a FIFO logic implemented using a RAM. Delayed signals from all channels forming a transducer array may be summed together 270 to create a scan line.

Left as such, the point-spread function may exhibit excessive sidelobes. Sidelobes occur because of the finite number of transducers 160 in the array, and can cause objects away from a target to interfere with a received signal. As a result, an image may appear slightly out of focus. In effect, the limited number of piezoelectric elements creates a spatial window. Since the amplitudes of all the signals are equal, the window is of the rectangular type. This window is known to have a poor sidelobe behavior. Apodization is a method known in the art to reduce sidelobe amplitude.

Apodization may be performed by changing the window and thus varying the amplitude of the delayed signals according to the position of the transducer in the array. To accomplish apodization within the transmit circuit 220 of one embodiment of the invention, a multiplier 260 can be placed between the LUT 207 and the DAC 225. Apodization may be provided to the receive circuit 230 by placing a multiplier 260 after the digital delay 250.

The receive 220 and transmit 230 beamforming circuits of an ultrasound system without apodization can be inexpensive, but may result in low image quality. On the other hand, the resolution of scans from systems with apodization, for example with the raised cosine window, may be improved but at a significant cost due to the need for multipliers. For this reason, the concept of noise shaping of spatial windows for apodization is introduced as an embodiment of the invention.

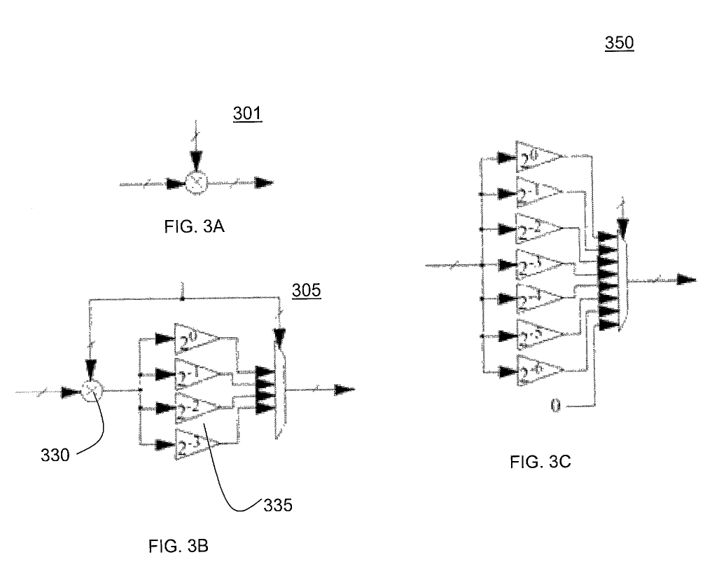

The multiplication operation can be simplified with respect to a full multiplier 301, as that shown in FIG. 3A. One method is the quantization of one operand to a small set of quantization levels. Constant values may lead to even more savings but in one embodiment of the invention, it may be assumed that both operands of the multiplier are time variant, or at least programmable. Different sets of quantization levels offer various cost and performance points. If the statistics of a signal are known, then quantization levels can be optimized for this particular signal.

A possible implementation of the multiplication operator is a floating-point multiplier 305 of FIG. 3B. The floating-point multiplier 305 consists of a reduced-precision multiplier 330 followed by a variable shift unit 335. The floating-point multiplier 305 is demonstrated with a 3-bit multiplier. To further simplify the full multiplication circuit 301 of FIG. 3A, the quantization levels may be restricted to powers of two. Multiplications with these values can be realized with bit shifts as illustrated in a variable shift multiplier 350 of FIG. 3C.

The complexity of the multiplier implementations 301, 305, and 350 may be quoted in equivalent NAND gates while performance can be indicated with the maximum signal-to-noise ratio of two types of signal encoded with the respective quantization levels. The first signal can be a triangular wave, which exhibits a constant density between the maximum and minimum values. The second signal can be a raised cosine signal that is more representative of the densities of windows. The full multiplier 301 has a complexity or “number of gates” of 1381 that directly influences its cost. Further, the full multiplier 301 it has 4096 quantization levels, a triangle wave signal-to-noise (SNR) ratio of 78.3 dB, and a raised cosine SNR ratio of 78.8 dB. The variable shift multiplier 350 as illustrated and has a complexity of 113 gates, 8 quantization levels, a triangle wave SNR of 14.5 dB and a raised cosine SNR of 16.2 dB. Additional embodiments of the invention may incorporate additional methods to quantize one of the operand, and implement a multiplier.

Noise shaping, a technique known in the art, allows the design of apodization capable receive and transmit channels, such as those previously illustrated in 210 of FIG. 2., without multipliers 260. A beamforming circuit with noise shaped apodization achieves much better performance than without apodization. For one embodiment of the invention the noise shaping technique, also labeled delta-sigma (ΔΣ) modulation, can involve the conversion of a signal into a quantized format where a quantization error can be purposely colored.

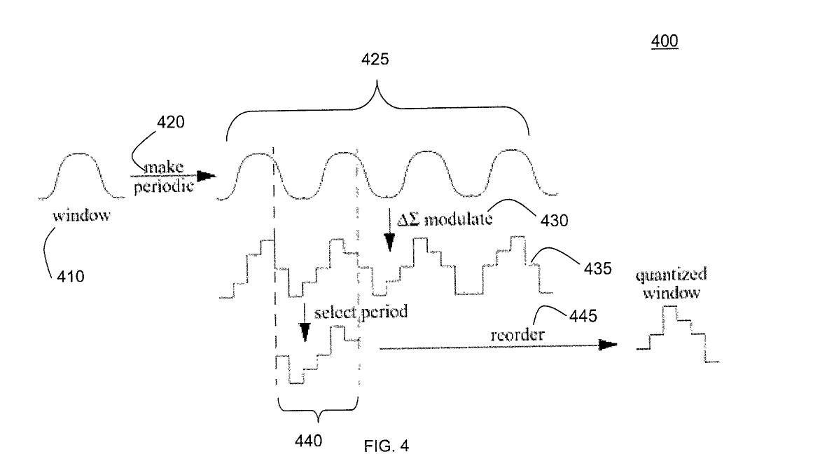

Illustrated in FIG. 4 is a method of operation required to encode a finite length signal 400 as required for one embodiment of the invention. The embodiment may require a window 410 to be passed through a ΔΣ modulator 430 to be encoded on a small number of quantization levels 435. However, because of transients caused by the internal state of ΔΣ modulators, they may realize a poor job of encoding finite length signals. Therefore, an additional embodiment of the invention may require the window 415 to first be made periodic 420 by repeating it 425. Even then, the output of the ΔΣ modulator 435 will not be periodic because of the strongly nonlinear behavior of the quantizer. Taking a subset 440 to represent window 415 may thus introduce distortion and increase in-band noise. A search process may be necessary to select a sequence that minimizes these effects. One alternative of the invention is to find the sequence with the smallest error power. After it has been identified, it may be necessary to rearrange the order 445 of the selected subset if the first element does not correspond to the first one of the window. It is important to note that for one embodiment of the invention, the operations 400 need to be performed only once to produce a quantized window 450. Therefore, the operations 400 do not require any processing power during normal scanning operations.

Even though the amplitude of the pulse signal 110 for each channel is quantized, deviations from the ideal of the amplitude response of transducers can be taken into account and corrected in totality. Calibration may be performed off-line, simplifying the circuits implementing the transmit and receive channels. The deviation of the transducers and their channels may then be integrated into the operation of the delta-sigma modulator 430. The set of quantization levels may be scaled by the inverse of the actual response of the transducer. In the feedback path of one embodiment of the invention, the actual response can be used to compute any error that needs to be filtered.

As mentioned in a previous embodiment, lowpass ΔΣ modulators may shape the quantization noise to high frequencies. Therefore, a window encoded with a lowpass ΔΣ modulator can retain the same response at low frequencies. In other words, the main lobe and the close sidelobes will remain the same. It is thus possible to achieve much better resolution with an encoded window than with no apodization. The downside of noise shaping is the high frequency noise that will appear in the form of lobes far from the main lobe. The amplitude of these lobes may depend on the set of quantization levels employed, and on the choice of a subset of the ΔΣ modulator output during the window encoding process. If the number of quantization levels is sufficiently large, then the far lobes will be acceptably small. In this case, an embodiment of the invention may implement a noise-shaped window in both the transmit and receive channels. In one embodiment, the encoding of the windows can be different to avoid enhancing noise peaks. If the amplitude of far lobes is unacceptable, then noise-shaped windows can be used in one of the channels, in combination with a full precision window on the other.

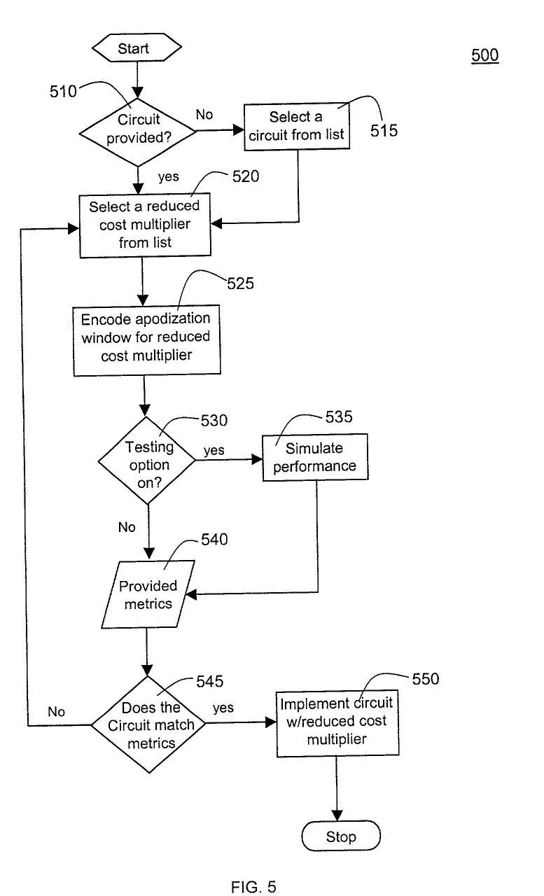

FIG. 5 is a flowchart illustration of one embodiment of the invention, a method for optimization of the apodization circuits 500. The embodiment begins by requesting if a apodization circuit has been provided 510, or does one have to be obtained 515. To obtain an apodization circuit, a list of applicable apodization circuits may be selected from 515. With an apodization circuit accessed, a listing of applicable reduced cost multipliers may be selected from 520 to be used as a replacement multiplier for the apodization circuit. After its integration within the apodization circuit, the characteristics of the replacement multiplier can be used to encode a apodization window utilizing a delta sigma modulator 525. An option of whether or not to test the new circuit may be offered 530 if a replacement multiplier has been arbitrarily selected as opposed to specifically selected. If requested, the apodization circuit can be simulated under operating parameters 535, and may next be examined using varying preselected metrics, which may include an examination of the point-spread function to determine sidelobe behavior 540. Another embodiment of the invention may not require any testing 535 or metric evaluation 540 and may proceed directly to the point of implementation 550.

With the completion of the metric evaluation 540, the decision of whether the apodization circuit is within minimum requirements can be made 545. If the apodization circuit is acceptable, the apodization circuit and its replacement multiplier may be implemented into production 550. If however, the apodization circuit is unacceptable, or if additional replacement multipliers are to be compared, the process may return to selecting a second reduced cost multiplier for a list 520.

The above described methods and implementation for optimization of apodization circuits are example methods and implementations. These methods and implementations illustrate one possible approach for optimizing apodization circuits. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim

1. A method for optimization of apodization circuits comprising:
providing an apodization circuit;
replacing a multiplier within the apodization circuit with a first replacement multiplier; and
replacing a window function of the apodization circuit with a first replacement window function.

2. The method of claim 1 wherein the providing of the apodization circuit comprises selecting the apodization circuit from a plurality of apodization circuits.

3. The method of claim 1 further comprising selecting the first replacement multiplier from a plurality of replacement multipliers.

4. The method of claim 1 further comprising the replacement of the multiplier by a memory device where all possible outcomes of the first replacement multiplier are stored.

5. The method of claim 1 wherein the first replacement window function is compatible with the first replacement multiplier.

6. The method of claim 1 further comprising:
applying a noise shaping technique to the window function of the selected apodization circuit; and
creating a first replacement window function based on the noise shaping technique of the window function of the apodization circuit.

7. The method of claim 1 further comprising:
applying the apodization circuit to a provided plurality of transducers;
applying an electric pulse to the plurality of transducers wherein the electric pulse is applied to each transducer within the plurality;
measuring the responses of the plurality of transducers based on the electric pulse applied to each transducer; and
applying a noise shaping technique to the window function of the selected apodization circuit, wherein the noise shaping technique accounts for the responses of the transducers.

8. The method of claim 1 further comprising determining a first efficiency rate for the apodization circuit with the first replacement multiplier and the first replacement window function.

9. The method of claim 8 further comprising:
replacing the first replacement multiplier within the apodization circuit with a second replacement multiplier;
replacing the first replacement window function within the apodization circuit with a second replacement window function;
determining a second efficiency rate for the apodization circuit with the second replacement multiplier and the second replacement window function;
comparing the first efficiency rate with the second efficiency rate; and
selecting between the apodization circuit with the first replacement multiplier and the first replacement window function and the apodization circuit with the second replacement multiplier and the second replacement window function, based on the comparing of the first efficiency rate with the second efficiency rate.

10. The method of claim 9 wherein the second replacement window function is suitable for use with the second replacement multiplier.

11. A system for optimization of apodization circuits comprising:
means for providing an apodization circuit;
means for replacing a multiplier within the apodization circuit with a first replacement multiplier; and
means for replacing a window function of the apodization circuit with a first replacement window function.

12. The system of claim 11 wherein the apodization circuit is selected from a plurality of apodization circuits.

13. The system of claim 11 further comprising means for selecting the first replacement multiplier from a plurality of replacement multipliers.

14. The system of claim 11 further comprising:
means for applying a noise shaping technique to a window function of the apodization circuit; and
means for creating a first replacement window function based on the noise shaping technique of the window function of the selected apodization circuit.

15. The system of claim 11 further comprising means for determining a first efficiency rate for the selected apodization circuit with the first replacement multiplier and the first replacement window function.

16. The system of claim 15 further comprising:
means for replacing the first replacement multiplier within the apodization circuit with a second replacement multiplier;
means for replacing the first replacement window function within the apodization circuit with a second replacement window function;
means for determining a second efficiency rate for the apodization circuit with the second replacement multiplier and the second replacement window function;
means for comparing the first efficiency rate with the second efficiency rate; and
means for selecting between the apodization circuit with the first replacement multiplier and the first replacement window function and the apodization circuit with the second replacement multiplier and the second replacement window function, based on the comparing of the first efficiency rate with the second efficiency rate.

17. A computer-usable medium storing a computer program, comprising:
computer-readable program code for providing an apodization circuit;
computer-readable program code for replacing a multiplier within the apodization circuit with a first replacement multiplier; and
computer-readable program code for replacing a window function of the apodization circuit with a first replacement window function.

18. The computer-usable medium of claim 17 wherein the apodization circuit is selected from a plurality of apodization circuits.

19. The computer-usable medium of claim 17 further comprising computer-readable program code for selecting the first replacement multiplier from a plurality of replacement multipliers.

20. The computer-usable medium of claim 17 further comprising:
computer-readable program code for applying a noise shaping technique to a window function of the apodization circuit; and
computer-readable program code for creating a first replacement window function based on the noise shaping technique of the window function of the apodization circuit.

21. The computer-usable medium of claim 17 further comprising computer-readable program code for determining a first efficiency rate for the apodization circuit with the first replacement multiplier and the first replacement window function.

22. The computer-usable medium of claim 21 further comprising:
computer-readable program code for replacing the first replacement multiplier within the apodization circuit with a second replacement multiplier;
computer-readable program code for replacing the first replacement window function within the apodization circuit with a second replacement window function;
computer-readable program code for determining a second efficiency rate for the apodization circuit with the second replacement multiplier and the second replacement window function;
computer-readable program code for comparing the first efficiency rate with the second efficiency rate; and
computer-readable program code for selecting between the apodization circuit with the first replacement multiplier and the first replacement window function and the apodization circuit with the second replacement multiplier and the second replacement window function, based on the comparing of the first efficiency rate with the second efficiency rate.
